(19) United States
(12) Patent Application Publication
(10) Pub. No.: US 2021/0034013 A1
(43) Pub. Date: Feb. 4, 2021

(54) SPATIAL LIGHT MODULATOR

(71) Applicant: ELECTRONICS AND TELECOMMUNICATIONS RESEARCH INSTITUTE, Daejeon (KR)

(72) Inventors: Seong-Mok CHO, Daejeon (KR); Yong Hae KIM, Daejeon (KR); Sang Hoon CHEON, Daejeon (KR); Kyunghee CHOI, Daejeon (KR); Chi-Sun HWANG, Daejeon (KR)

(73) Assignee: ELECTRONICS AND TELECOMMUNICATIONS RESEARCH INSTITUTE, Daejeon (KR)

(21) Appl. No.: 16/846,857

(22) Filed: Apr. 13, 2020

(30) Foreign Application Priority Data
Aug. 1, 2019 (KR) 10-2019-0093857

(51) Int. Cl. G03H 1/22; G02F 1/01

(52) U.S. Cl. CPC G03H 1/2202; G02F 1/0102; G02F 2203/12; G02F 2203/01; G03H 2225/55

(57) ABSTRACT

A spatial light modulator according to the inventive concept includes a light modulation layer including a plurality of pixels arranged on a plane perpendicular to a first direction, a first lens array including first lenses corresponding one-to-one with the pixels, a second lens array including second lenses corresponding one-to-one with the first lenses, and a spacer layer between the first lens array and the second lens array. Each of the first lenses has a first central axis extending in the first direction and the first central axes of the first lenses meet at different positions for each of the pixels.

### CROSS-REFERENCE TO RELATED APPLICATIONS

This U.S. non-provisional patent application claims priority under 35 U.S.C. § 119 of Korean Patent Application No. 10-2019-0093857, filed on Aug. 1, 2019, the entire contents of which are hereby incorporated by reference.

### BACKGROUND

The present disclosure relates to a spatial light modulator, and more particularly, to a spatial light modulator for implementing a holographic image.

A hologram records an interference pattern created by interfering an object wave and a reference wave diffracted by a three-dimensional object, and is an imaging technique that uses the principle that the object wave is reproduced when the reference wave is irradiated on the recorded interference fringe again. A hologram records information on optical phase diffracted in a three-dimensional object. Unlike traditional eyeglass and glass-free three-dimensional display techniques that use binocular parallax, a hologram is evaluated as an ideal three-dimensional display because there is no limit on the position of the observer and there is no eye fatigue due to binocular disparity.

Unlike an analog hologram that creates a hologram by recording the interference fringe directly on the photographic plate with a laser, digital hologram technology uses computer image processing technology to calculate the expected interference pattern by a computer, and then, creates a holographic image by expressing the expected interference pattern through a spatial light modulator (SLM). At this time, the SLM refers to any device that can change the amplitude or phase information of the incident light according to the position.

### SUMMARY

The present disclosure provides a spatial light modulator with an improved viewing angle when implementing a holographic image.

An embodiment of the inventive concept provides a spatial light modulator includes: a light modulation layer including a plurality of pixels arranged on a plane perpendicular to a first direction; a first lens array including first lenses corresponding one-to-one with the pixels; a second lens array including second lenses corresponding one-to-one with the first lenses; and a spacer layer between the first lens array and the second lens array, wherein each of the first lenses has a first central axis extending in the first direction, wherein the first central axes of the first lenses meet at different positions for each of the pixels.

In an embodiment, each of the second lenses may have a second central axis passing a center of the second lenses and extending in the first direction, wherein the first central axes of the first lenses may coincide with the second central axes of the respectively corresponding second lenses.

In an embodiment, the first lenses may have a first focal length, wherein the second lenses may have a second focal length, wherein the first focal length may be greater than the second focal length.

In an embodiment, a thickness of the spacer layer in the first direction may be equal to a sum of the first focal length and the second focal length.

In an embodiment, a longest length of the first lenses in a second direction perpendicular to the first direction may be greater than a longest length of the second lenses in the second direction.

In an embodiment, the spatial light modulator may further include a pinhole array on the second lens array.

In an embodiment, the pinhole array may include a plurality of pinholes one-to-one corresponding to the second lenses, wherein a width of the pinholes in a second direction perpendicular to the first direction may be smaller than a longest length of the second lenses in the second direction.

In an embodiment, each of the second lenses may have a second central axis passing a center of the second lenses and extending in the first direction, wherein the first central axes of the first lenses may be spaced apart from the second central axes of respectively corresponding second lenses in a second direction perpendicular to the first direction.

In an embodiment, the spatial light modulator may further include a pinhole array on the second lens array, wherein the pinhole array may include a plurality of pinholes corresponding one-to-one with the second lenses.

In an embodiment, the first lenses and the second lenses may be any one of a meta-lens and a Fresnel lens.

In an embodiment of the inventive concept, a spatial light modulator includes: a light modulation layer to which an input beam is irradiated; a first lens array and a second lens array configured to refract the input beam to emit a transmission beam; and a spacer layer between the first lens array and the second lens array, wherein the first lens array includes first lenses, wherein the second lens array includes second lenses that correspond one-to-one with the first lenses, wherein each of the first lenses has a first central axis extending in a direction perpendicular to an upper surface of the light modulation layer, wherein the first central axes are spaced apart from each other, wherein separation distances between the first central axes are different from each other.

In an embodiment, the light modulation layer may include a plurality of pixels, wherein the first lenses may correspond one-to-one with the pixels.

In an embodiment, the second lenses may overlap the corresponding first lens in a direction in which the input beam is irradiated.

In an embodiment, the input beam may have a greater width of a cross section perpendicular to a direction, through which the input beam and the transmission beam travel, than the transmission beam.

In an embodiment, the first lens array and the second lens array may be spaced apart in a traveling direction of the input beam.

In an embodiment, the spatial light modulator may further include a pinhole array for blocking a portion of the transmission beam to limit a size of beam.

In an embodiment, the first lenses may have a first focal length, wherein the second lenses may have a second focal length, wherein the first focal length may be greater than the second focal length.

In an embodiment, the first lenses and the second lenses may be any one of a meta-lens and a Fresnel lens.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIGS. 1 to 6 are cross-sectional views illustrating spatial light modulators according to embodiments of the inventive concept.

### DETAILED DESCRIPTION

In order to fully understand the configuration and effects of the technical spirit of the inventive concept, preferred embodiments of the technical spirit of the inventive concept will be described with reference to the accompanying drawings.

However, the technical spirit of the inventive concept is not limited to the embodiments set forth herein and may be implemented in various forms and various modifications may be applied thereto. Only, the technical spirit of the inventive concept is disclosed to the full through the description of the embodiments, and it is provided to those skilled in the art that the inventive concept belongs to inform the scope of the inventive concept completely. In the accompanying drawings, for convenience of explanation, the components are enlarged in size than the actual size, and the proportions of each component can be exaggerated or reduced.

The terms used in this specification are used only for explaining specific embodiments while not limiting the inventive concept. Unless otherwise the terms used in embodiments of the inventive concept are defined differently, they may be interpreted as commonly known to those skilled in the art.

The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

Where a layer is referred to herein as ‘on’ another layer, it may be formed directly on the upper surface of the other layer or with a third layer interposed therebetween.

It will be understood that the terms “first”, “second”, and “third” are used herein to describe various regions, films (or layers), and so on, but these regions, films (or layers), and so on should not be limited by these terms. These terms are only used to distinguish any given region or layer from other regions or layers. Thus, the portion referred to as the first portion in one embodiment may be referred to as the second portion in other embodiments. Embodiments described herein include complementary embodiments thereof. Like reference numerals refer to like components throughout the specification.

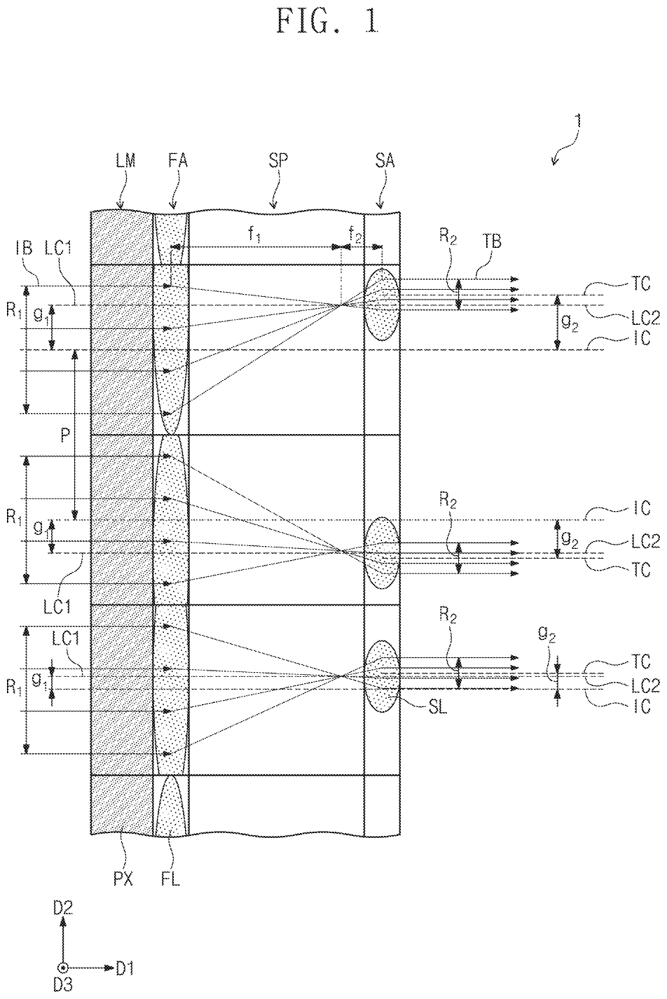

Hereinafter, embodiments of a spatial light modulator according to the inventive concept will be described in detail with reference to FIGS. 1 to 6.

FIGS. 1 to 6 are cross-sectional views illustrating spatial light modulators according to embodiments of the inventive concept.

Referring to FIG. 1, the spatial light modulator 1 according to an embodiment of the inventive concept may include a light modulation layer LM, a first lens array FA, a second lens array SA, and a spacer layer SP.

The light modulation layer LM may include a plurality of pixels PX. The upper surface of the light modulation layer LM may be perpendicular to the first direction D1. Hereinafter, the upper surface may mean a surface facing the first direction D1 in each layer. The pixels PX may be arranged on a plane perpendicular to the first direction D1. The pixels PX may be arranged in the second direction D2 and the third direction D3. Hereinafter, although three pixels PX are shown in FIGS. 1 to 6, more pixels PX may be arranged in the second direction D2 and the third direction D3. The second direction D2 and the third direction D3 may be perpendicular to the first direction D1. The second direction D2 and the third direction D3 may be perpendicular to each other. For example, the pixels PX may have substantially the same length in the second direction D2 and in the third direction D3. That is, the upper surface of the pixels PX may have a square shape. However, this is merely an example, and the inventive concept is not limited thereto. The upper surface of the pixels PX may have various shapes such as circles, ellipses, rectangles, and rhombuses. In addition, unlike those shown in the drawings, the pixels PX may be spaced apart from each other in the second direction D2 and/or the third direction D3.

The input beam IB parallel to the first direction D1 may be irradiated toward the pixels PX. The central axis of each of the pixels PX may be substantially the same as the central axis IC of the input beam IB irradiated to each of the pixels PX. The pixel spacing P may be defined as the distance between the central axes of the pixels PX. The pixel spacing P may be substantially equal to the distance between the central axes IC of the input beam IB irradiated to each of the pixels PX. The pixel spacing P may be greater than or equal to the length of each pixel PX in the second direction D2 or the third direction D3. The diameter R₁ of the input beam IB may be defined as the length in the second direction D2 of the cross section of the input beam IB. The cross section of the input beam IB may be a cross section cut in a plane perpendicular to the first direction D1 through which the input beam IB travels. The diameter R₁ of the input beam IB may be smaller than the pixel spacing P. In addition, the diameter R₁ of the input beam IB may be smaller than or equal to the length of each pixel PX in the second direction D2 or the third direction D3.

The first lens array FA may be provided on the upper surface of the light modulation layer LM. The first lens array FA may include first lenses FL. The first lenses FL may be provided on the upper surface of the pixels PX. The first lenses FL may contact the upper surfaces of the pixels PX. For example, the first lenses FL may contact the upper surfaces of the pixels PX in the thickest portion in the first direction D1. Each of the first lenses FL may have substantially the same thickness as the thickest portion in the first direction D1. In addition, the first lenses FL may have substantially the same focal length. For example, the first lenses FL may have a first focal length f₁. In view of the cross-sectional area of FIG. 1, the first lenses FL may have a shape in which a circle or an ellipse is cut to fit the upper surfaces of the pixels PX.

The first lenses FL may overlap each pixel PX in the first direction D1. The first lenses FL may correspond one-to-one with each pixel PX overlapping in the first direction D1. For example, the first lenses FL may contact the pixels PX at random positions. In the following description, random may mean that the position, spacing, size, etc. are different for each pixel PX. The central axis LC1 of each of the first lenses FL may be defined by a line that passes through a thickest portion in each of the first lenses FL in the first direction D1 and extends in parallel with the first direction D1. In this case, the central axis LC1 of each of the first lenses FL may meet each of the pixels PX. The central axis LC1 of each of the first lenses FL may meet at different positions for each pixel PX. In addition, the central axis LC1 of each of the first lenses FL may be spaced apart from the central axis IC of the input beam IB to be irradiated in the second direction D2. The first spacing g₁ may be defined by a distance in which the central axis LC1 of each of the first lenses FL and the central axis IC of the input beam IB are spaced apart in the second direction D2. The first spacing g₁ may be different for each pixel PX. The first spacing g₁ may be greater than or equal to zero. In addition, the first spacing g₁ may be smaller than half of the pixel spacing P.

The second lens array SA may be provided on the upper surface of the first lens array FA. The second lens array SA may include second lenses SL. The second lenses SL may be smaller in size than the first lenses FL. More specifically, the longest length of each of the second lenses SL in the second direction D2 may be smaller than the longest length of each of the first lenses FL in the second direction D2. In addition, the longest length of each of the second lenses SL in the second direction D2 may be smaller than the length of each pixel PX in the second direction D2 or the third direction D3. Each of the second lenses SL may have substantially the same thickness as the thickest portion in the first direction D1. In addition, the second lenses SL may have substantially the same focal length. For example, the second lenses SL may have a second focal length f₂. The second focal length f₂ may be smaller than the first focal length f₁.

The second lenses SL may overlap the pixels PX and the first lenses FL in the first direction D1. The second lenses SL may correspond one-to-one with the pixels PX and the first lenses FL, which overlap each other in the first direction D1. The second lenses SL may be spaced apart from the corresponding first lenses FL in the first direction D1. For example, the separation distance between the first lenses FL and the second lenses SL may be substantially equal to the sum of the first focal length f₁ and the second focal length f₂. The central axis LC2 of each of the second lenses SL may be defined by a line that passes through a thickest portion in each of the second lenses SL in the first direction D1 and extends in parallel with the first direction D1. Alternatively, the central axis LC2 of each of the second lenses SL may be defined by a line that passes through the center of each of the second lenses SL and extends in parallel with the first direction D1. For example, the central axis LC2 of each of the second lenses SL may be substantially the same as the central axis LC1 of each of the corresponding first lenses FL.

A transmission beam TB parallel to the first direction D1 may be emitted through the second lenses SL. In this case, the central axis LC2 of each of the second lenses SL may be spaced apart from the central axis TC of the emitted transmission beam TB in the second direction D2. The second spacing g₂ may be defined by a distance in which the central axis TC of the transmission beam TB and the central axis IC of the input beam IB are spaced apart in the second direction D2. The second spacing g₂ may be different for each pixel PX. The second spacing g₂ may be greater than or equal to zero. In addition, the second spacing g₂ may be smaller than half of the pixel spacing P. The second spacing g₂ and the first spacing g₁ may satisfy Equation 1 below. That is, the second spacing g₂ may be larger than the first spacing g₁.

$${g}_{2} = \frac{{f}_{1} + {f}_{2}}{{f}_{1}} \times {g}_{1} \qquad [ Equation 1 ]$$

In Equation 1, if the first focal length f₁ is sufficiently large compared to the second focal length f₂ (f₁>f₂), the second spacing g₂ may be approximately the same as the first spacing g₁. When such approximation is possible, the degree in which the central axis LC1 of each of the first lenses FL is spaced apart from the central axis IC of the input beam IB in the second direction D2 determines the location of the transmission beam TB. That is, a random arrangement of each of the first lenses FL may randomly position the transmission beam TB.

The diameter R₂ of the transmission beam TB may be defined by the length in the second direction D2 of the cross section of the transmission beam TB. The cross section of the transmission beam TB may be a cross section cut in a plane perpendicular to the first direction D1 through which the transmission beam TB travels. The diameter R₂ of the transmission beam TB may be smaller than the diameter R₁ of the input beam IB. The diameter R₂ of the transmission beam TB and the diameter R₁ of the input beam IB may satisfy Equation 2 below. Equation 2 means that the beam is focused while passing through the first lens array FA and the second lens array SA.

$${R}_{2} = \frac{{f}_{2}}{{f}_{1}} \times {R}_{1} \qquad [ Equation 2 ]$$

However, the beam may not be focused indefinitely due to the diffraction limit. The diffraction limit refers to the theoretical limit of the resolution of the optical system due to the diffraction of light. As a result, the beam passing through the first lens array FA and the second lens array SA may not be fully focused to one point and may have a finite size. More specifically, when the first focal length f₁ is increased by a certain degree or more, the diameter R₂ of the transmission beam TB may not be as small as that calculated by Equation 2. Accordingly, when designing the first lens array FA and the second lens array SA, the diffraction limit may be considered as the beam focusing limit.

The first and second lenses FL and SL may be, for example, spherical lenses. Hereinafter, although the first and second lenses FL and SL are illustrated as spherical lenses in FIGS. 1 to 6, the inventive concept is not limited thereto, and the first and second lenses FL and SL may be cylindrical lens. In the case of the cylindrical lens, the input beam IB and the transmission beam TB may be linearly focused. In order to expand the viewing angle in the horizontal direction and to provide a three-dimensional effect through pupil tracking in the vertical direction, cylindrical lenses can be utilized.

A spacer layer SP may be provided between the first lens array FA and the second lens array SA. The first lenses FL may contact the lower surface of the spacer layer SP, and the second lenses SL may contact the upper surface of the spacer layer SP. The spacer layer SP may fix the positions of the first lens array FA and the second lens array SA. The thickness of the spacer layer SP in the first direction D1 may be substantially equal to the sum of the first focal length f₁ and the second focal length f₂.

In the spatial light modulator 1 according to an embodiment of the inventive concept, the central axis LC1 of each of the first lenses FL contacts the corresponding pixels PX at a random position so that the location of the transmission beam TB can be made random. Since the transmission beam TB focused at a random position has a diameter R₂ smaller than the diameter R₁ of the input beam IB, it may have higher spatial frequency components. In addition, due to the random position of the transmission beam TB, the periodic repetition of the hologram image generated by the periodicity of the pixels PX may be eliminated. Through this, a large viewing angle may be realized in the hologram image.

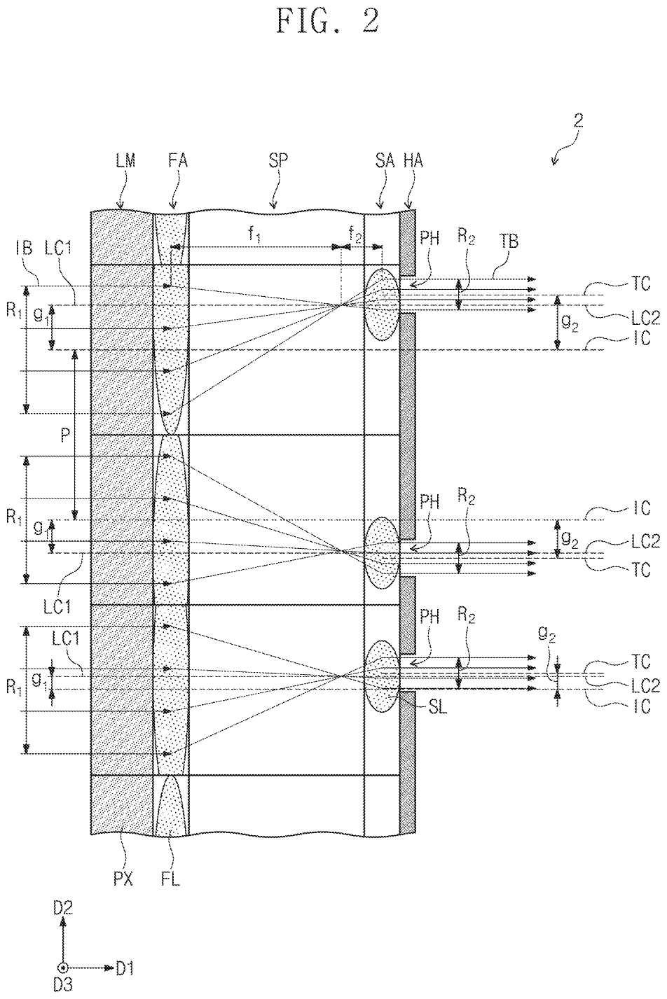

Referring to FIG. 2, the spatial light modulator 2 according to another embodiment of the inventive concept may include a light modulation layer LM, a first lens array FA, a second lens array SA, a spacer layer SP, and a pinhole array HA. The spatial light modulator 2 according to the present embodiment is substantially the same as or similar to the spatial light modulator 1 described with reference to FIG. 1 except for the description below.

The pinhole array HA may be provided on the upper surface of the second lens array SA. The pinhole array HA may include pinholes PH. The pinholes

PH may correspond one-to-one with each of the second lenses SL. The pinholes PH may expose portions of the second lenses SL to the outside. The width of the pinholes PH in the second direction D2 may be smaller than the longest length of the second lenses SL in the second direction D2. The width of the pinholes PH in the second direction D2 may be smaller than or equal to the diameter R₂ of the transmission beam TB. The pinholes PH may more accurately limit the diameter R₂ and the position of the transmission beam TB. In addition, a portion of the transmission beam TB passing through the second lens array SA may be blocked by the pinhole array HA. When the pinhole array HA blocks a part of the transmission beam TB, the transmission beam TB may be focused in a narrower area. Accordingly, the spatial light modulator 2 can express higher spatial frequency information, and the viewing angle can be further improved.

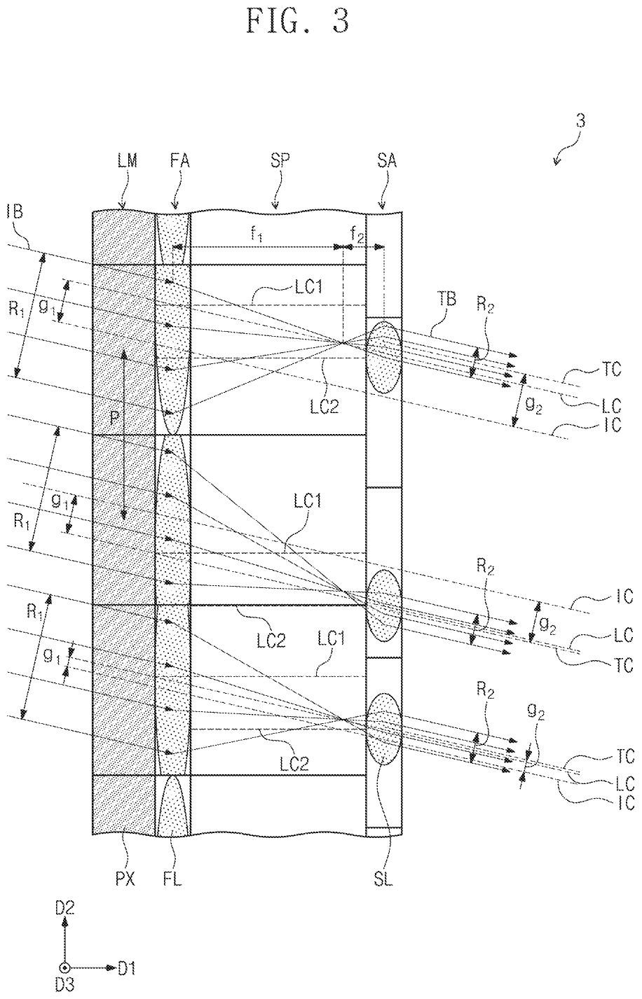

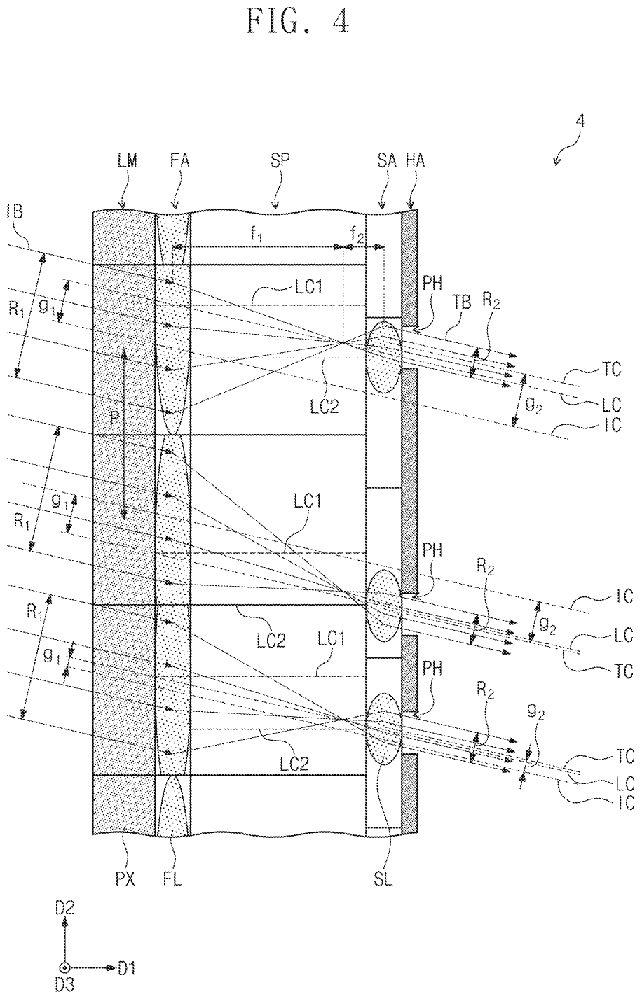

The spatial light modulators 3 and 4 shown in FIGS. 3 and 4 are substantially the same as or similar to the spatial light modulators 1 and 2 described with reference to FIGS. 1 and 2 except for the description below.

Referring to FIGS. 3 and 4, the input beam IB may be irradiated to the light modulation layer LM with an inclination with respect to the first direction D1. The center connection line LC connecting the center of each of the second lenses SL corresponding to the center of each of the first lenses FL may extend in a direction parallel to the input beam IB. The center of each of the first and second lenses FL and SL may be the midpoint of the thickest portion in the first direction D1 in each of the first and second lenses FL and SL. In this case, the central axis LC2 of each of the first lenses FL and the central axis LC2 of each of the second lenses SL may not coincide with each other. More specifically, the central axis LC1 of each of the first lenses FL and the central axis LC2 of each of the corresponding second lenses SL may be spaced apart in the second direction D2. Also, unlike FIGS. 1 and 2, the first spacing g₁ may be defined by a distance where the center connection line LC and the central axis IC of the input beam IB are spaced apart from each other in a direction perpendicular to the irradiation direction of the input beam IB. In such a manner, the second spacing g₂ may be defined by a distance where the central axis TC of the transmission beam TB and the central axis IC of the input beam IB are spaced apart from each other in a direction perpendicular to the irradiation direction of the input beam IB. In order to filter out non-diffracted light components during hologram formation, as shown in FIGS. 3 and 4, the input beam IB may have an inclination with respect to the first direction D1.

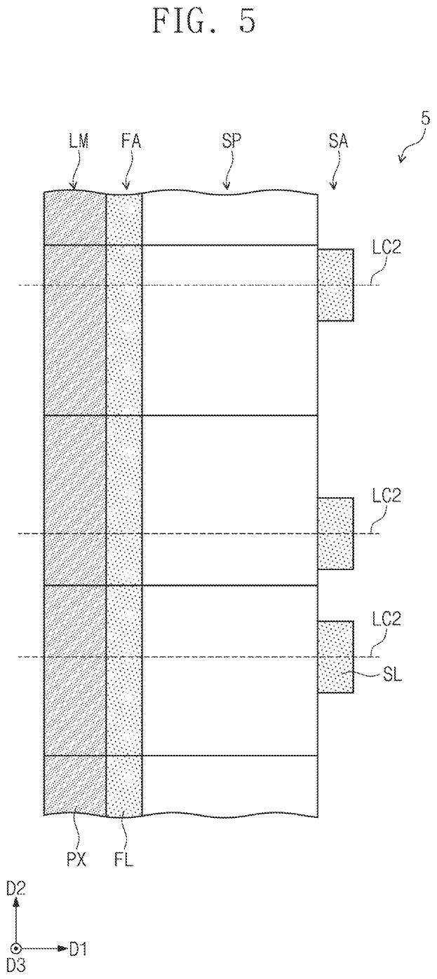

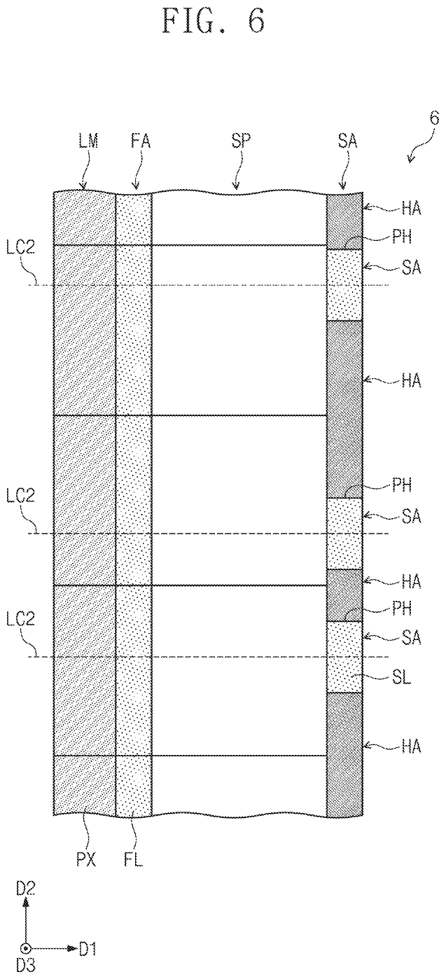

The spatial light modulators 5 and 6 shown in FIGS. 5 and 6 are substantially the same as or similar to the spatial light modulators 1 and 2 described with reference to FIGS. 1 and 2 except for the description below.

Referring to FIGS. 5 and 6, the first and second lens arrays FA and SA may include a meta-lens or a Fresnel lens. The meta-lens is a flat lens with no bends, and is a lens containing nano-sized fins instead of bends. The nano-sized fins may include, for example, titanium dioxide (TiO2), which is a highly reflective material. In addition, Fresnel lens is a lens that replaces the curved surface of the general optical lens with a series of concentric grooves. The Fresnel lens may include a continuous concentric groove. Aspheric lenses, such as meta-lenses or Fresnel lenses, may have a larger focusing effect with a thickness thinner than spherical lenses. In addition, aspherical lenses, such as meta-lenses or Fresnel lenses, may have less spherical aberration than spherical lenses.

When the first and second lens arrays FA and SA include a meta-lens or a Fresnel lens, the spacer layer SP may be a transparent substrate. In addition, the pinhole array HA may be provided on substantially the same plane as the second lens array SA. For example, an upper surface of the pinhole array HA and an upper surface of the second lens array SA may form a coplanar surface. In this case, the pinhole array HA may be formed in the same process step as the second lens array SA. That is, the first and second lens arrays FA and SA including a meta-lens or Fresnel lens and the pinhole array HA may be conveniently manufactured in the process.

The first lenses FL may have substantially the same length in the second direction D2 and/or in the third direction D3. That is, the first lenses FL may be provided to cover the respective corresponding pixels PX. Meanwhile, the central axis LC2 of each of the second lenses SL may be defined by a line that passes through the center of each of the second lenses SL and extends in parallel with the first direction D1. In this case, the central axis LC2 of each of the second lenses SL may meet one of the corresponding first lenses FL. The central axis LC2 of each of the second lenses SL may meet at different positions of each of the first lenses FL.

The spatial light modulator according to the embodiments of the inventive concept may focus the input beam irradiated as the transmission beam at a random position without degrading the light efficiency.

In addition, the spatial light modulator according to the embodiments of the inventive concept can focus the transmission beam at a random position to greatly improve the viewing angle when implementing the hologram image.

Although the exemplary embodiments of the inventive concept have been described, it is understood that the inventive concept should not be limited to these exemplary embodiments but various changes and modifications can be made by one ordinary skilled in the art within the spirit and scope of the inventive concept as hereinafter claimed.

What is claimed is:

1. A spatial light modulator comprising:
a light modulation layer including a plurality of pixels arranged on a plane perpendicular to a first direction;
a first lens array including first lenses corresponding one-to-one with the pixels;
a second lens array including second lenses corresponding one-to-one with the first lenses; and
a spacer layer between the first lens array and the second lens array,
wherein each of the first lenses has a first central axis extending in the first direction,
wherein the first central axes of the first lenses meet at different positions for each of the pixels.

2. The spatial light modulator of claim 1, wherein each of the second lenses has a second central axis passing a center of the second lenses and extending in the first direction,
wherein the first central axes of the first lenses coincide with the second central axes of the respectively corresponding second lenses.

3. The spatial light modulator of claim 1, wherein the first lenses have a first focal length,
wherein the second lenses have a second focal length,
wherein the first focal length is greater than the second focal length.

4. The spatial light modulator of claim 3, wherein a thickness of the spacer layer in the first direction is equal to a sum of the first focal length and the second focal length.

5. The spatial light modulator of claim 1, wherein a longest length of the first lenses in a second direction perpendicular to the first direction is greater than a longest length of the second lenses in the second direction.

6. The spatial light modulator of claim 1, further comprising a pinhole array on the second lens array.

7. The spatial light modulator of claim 6, wherein the pinhole array comprises a plurality of pinholes one-to-one corresponding to the second lenses,
wherein a width of the pinholes in a second direction perpendicular to the first direction is smaller than a longest length of the second lenses in the second direction.

8. The spatial light modulator of claim 1, wherein each of the second lenses has a second central axis passing a center of the second lenses and extending in the first direction,
wherein the first central axes of the first lenses are spaced apart from the second central axes of respectively corresponding second lenses in a second direction perpendicular to the first direction.

9. The spatial light modulator of claim 8, further comprising a pinhole array on the second lens array,
wherein the pinhole array comprises a plurality of pinholes corresponding one-to-one with the second lenses.

10. The spatial light modulator of claim 1, wherein the first lenses and the second lenses are any one of a meta-lens and a Fresnel lens.

11. A spatial light modulator comprising:
a light modulation layer to which an input beam is irradiated;
a first lens array and a second lens array configured to refract the input beam to emit a transmission beam; and
a spacer layer between the first lens array and the second lens array,
wherein the first lens array comprises first lenses,
wherein the second lens array comprises second lenses that correspond one-to-one with the first lenses,
wherein each of the first lenses has a first central axis extending in a direction perpendicular to an upper surface of the light modulation layer,
wherein the first central axes are spaced apart from each other,
wherein separation distances between the first central axes are different from each other.

12. The spatial light modulator of claim 11, wherein the light modulation layer comprises a plurality of pixels,
wherein the first lenses correspond one-to-one with the pixels.

13. The spatial light modulator of claim 11, wherein the second lenses overlap the corresponding first lens in a direction in which the input beam is irradiated.

14. The spatial light modulator of claim 11, wherein the input beam has a greater width of a cross section perpendicular to a direction, through which the input beam and the transmission beam travel, than the transmission beam.

15. The spatial light modulator of claim 11, wherein the first lens array and the second lens array are spaced apart in a traveling direction of the input beam.

16. The spatial light modulator of claim 11, further comprising a pinhole array for blocking a portion of the transmission beam to limit a size of beam.

17. The spatial light modulator of claim 11, wherein the first lenses have a first focal length,
wherein the second lenses have a second focal length,
wherein the first focal length is greater than the second focal length.

18. The spatial light modulator of claim 11, wherein the first lenses and the second lenses are any one of a meta-lens and a Fresnel lens.
